(19) United States
(12) Patent Application Publication
(10) Pub. No.: US 2006/0160586 A1
(43) Pub. Date: Jul. 20, 2006

(54) Changeable mobile phone leather cover

(76) Inventor: Yung-Fa Cheng, Taipei Shien (TW)

Correspondence Address: RABIN & BERDO, P.C., Suite 500, 1101 14 Street, N.W., Washington, DC, 20005, US

(21) Appl. No.: 11/258,031

(22) Filed: Oct. 26, 2005

(30) Foreign Application Priority Data
Jan. 14, 2005 (TW) 94200794

(51) Int. Cl. H04M 1/00

(52) U.S. Cl. 455/575.8

(57) ABSTRACT

A changeable mobile phone leather cover is described. The changeable mobile phone leather cover includes a leather front cover, a flexible portion, and a leather back cover. The leather front cover and the leather back cover are made of fixing plates covered by a leather layer. The flexible portion is preferably made of the leather layer. The fixing plate further includes a plurality of fixing devices for coupling to a mobile phone fixing frame so that the changeable mobile phone leather cover can be quickly and easily installed on and removed from the mobile phone fixing frame.

### RELATED APPLICATIONS

The present application is based on, and claims priority from, Taiwan Application Serial Number 94200794, filed Jan. 14, 2005, the disclosure of which is hereby incorporated by reference herein in its entirety.

### FIELD OF THE INVENTION

The present invention generally relates to a mobile phone with a leather cover. More particularly, the present invention relates to a mobile phone with a changeable leather cover.

### BACKGROUND OF THE INVENTION

Since wireless telecommunication technology has extensively progressed, the mobile phone has become a very portable yet powerful electronic device and can be used nearly anytime and anywhere. The mobile phone has become an important and ubiquitous information tool for the modern human.

Due to the current widespread use of mobile phones, manufacturers exert substantial effort designing more attractive appearances and more powerful functions for the mobile phones to attract the attention of and purchase by consumers. Some mobile phones include a changeable cover such that their appearance can be altered according to user desires.

However, most mobile phone covers are made of hard material such as plastic or metal. Therefore, the mobile phone cover feels cold to the touch. The feel of a leather cover is warmer than the plastic or metal cover. However, the leather cover cannot effectively protect the mobile phone. Accordingly, users desire a mobile phone with a changeable cover having the leather feel and appearance yet being able to protect the mobile phone.

### SUMMARY OF THE INVENTION

It is an object of the present invention to provide a mobile phone cover made of leather and changeable according to a user's desire.

It is another object of the present invention to provide a changeable mobile phone leather cover with a hard fixing plate so as to conveniently exchange the changeable mobile phone leather cover and further protect the interior components and module in the mobile phone.

To accomplish the above objectives, the present invention provides a changeable mobile phone leather cover. The changeable mobile phone leather cover includes a leather front cover, a flexible portion, and a leather back cover. The leather front cover is composed of a leather layer covering a first fixing plate, and the leather back cover is composed of a leather layer covering a second fixing plate. The flexible portion is preferably formed by a leather layer extended from the leather front cover and/or the leather back cover.

The first and second fixing plates further include a plurality of fixing devices for coupling to a mobile phone fixing frame. For example, the changeable mobile phone leather cover is fixed to the mobile phone by a plurality of screws coupling to the fixing devices through a plurality of fixing holes on the mobile phone fixing frame. Optionally, the fixing devices can be composed of a plurality of hooks coupling to the fixing holes on the mobile phone fixing frame so as to fix the changeable mobile phone leather cover on the mobile phone.

In addition, a display module, a keyboard module and a battery module are disposed inside the mobile phone fixing frame and the changeable mobile phone leather cover. In one preferred embodiment, a same leather layer covers the first fixing plate, the second fixing plate, and the flexible portion. The first fixing plate and the second fixing plate are preferably made of a metal material or a plastic material.

Hence, the changeable mobile phone leather cover according to the present invention can quickly and easily couple to the fixing frame of the mobile phone so as to rapidly change the leather cover of the mobile phone and provide for the mobile phone a leather appearance and touch similar to a leather wallet. Accordingly, the touch, quality, and value of the mobile phone are increased.

### BRIEF DESCRIPTION OF THE DRAWINGS

The foregoing aspects and many of the attendant advantages of this invention are more readily appreciated as the same become better understood by reference to the following detailed description, when taken in conjunction with the accompanying drawings, wherein:

FIG. 1A is a schematic view of a display panel module, a keyboard module, and a battery module for a changeable mobile phone leather cover according to the present invention;

FIG. 1B is a schematic view of a fixing frame for a changeable mobile phone leather cover according to the present invention;

FIG. 1C is a preferred embodiment of a changeable mobile phone leather cover according to the present invention; and

FIG. 1D is another preferred embodiment of a changeable mobile phone leather cover according to the present invention.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

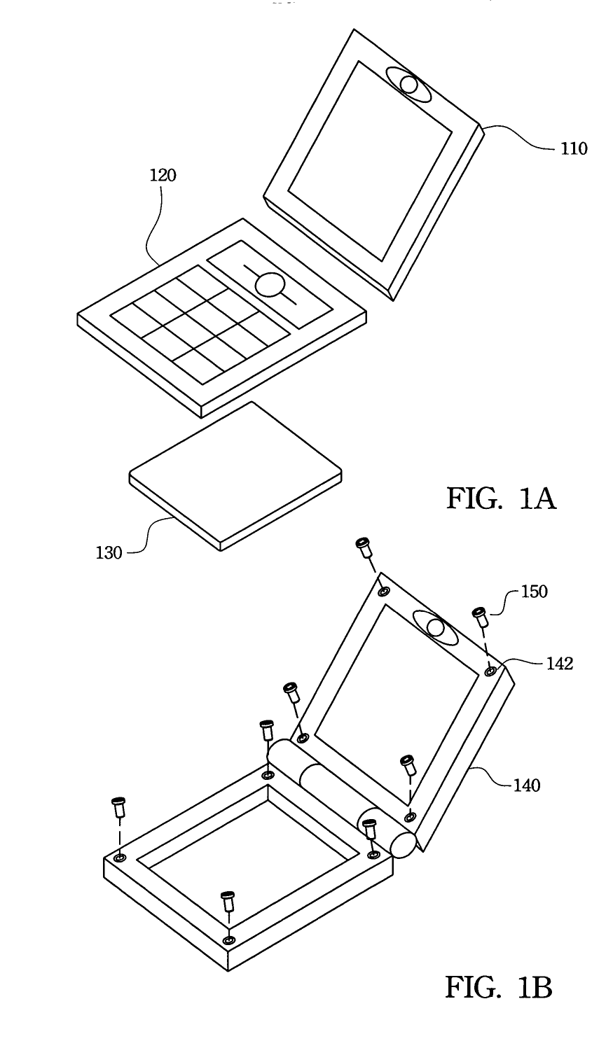

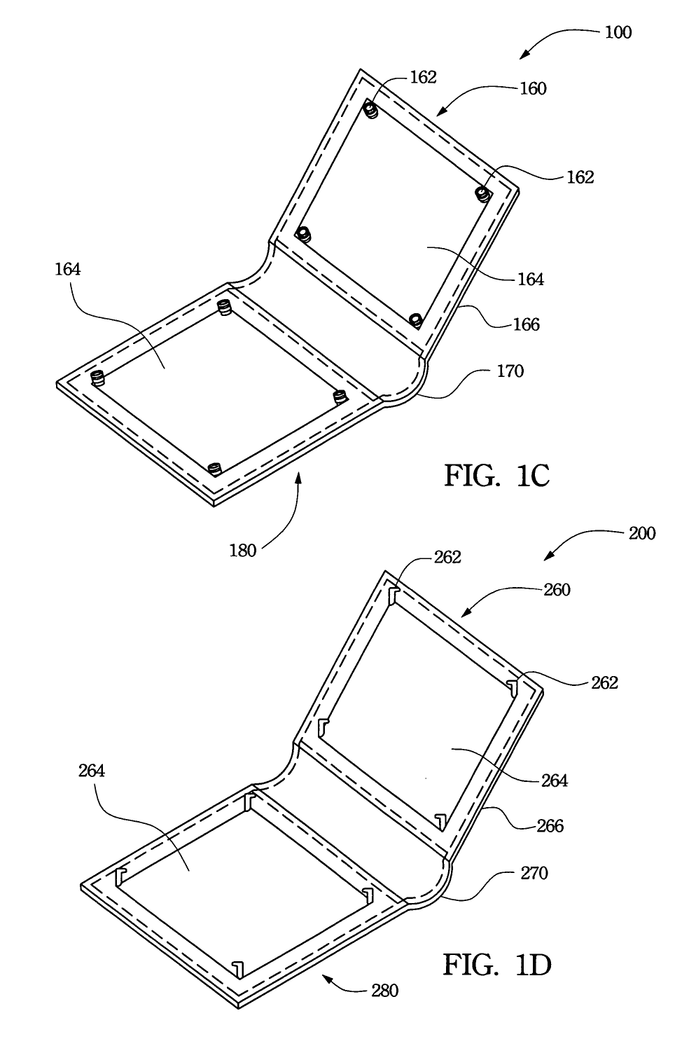

FIGS. 1A to 1D are schematic views of changeable mobile phone leather covers according to the present invention. FIG. 1A illustrates a display panel module, a keyboard module, and a battery module for a changeable mobile phone leather cover. FIG. 1B illustrates a fixing frame thereof. FIG. 1C is a preferred embodiment of the changeable mobile phone leather cover according to the present invention, and FIG. 1D is another preferred embodiment thereof.

Referring to FIGS. 1A to 1C, a changeable mobile phone leather cover 100 is fixed on an outside of the fixing frame 140, and a display panel module 110, a keyboard module 120 and a battery module 130 are fixed on an inside of the fixing frame 140.

The changeable mobile phone leather cover 100 includes a front cover 160, a flexible portion 170, and a back cover 180. The front cover 160 is formed by a leather layer 166 covered on a fixing plate 164 and is coupled to the back cover 180 by the flexible portion 170. The flexible portion 170 is preferably formed by the leather layer 166 extending from the front cover 160. The back cover 180 is also formed by a leather layer covering a fixing plate 164, and the leather layer of the back cover 180 is preferably formed by the leather layer 166 extending from the front cover 160. In addition, the fixing plate 164 is preferably made of a metal material or a plastic material.

Therefore, a mobile phone adopting the changeable mobile phone leather cover 100 presents a leather cover to effectively transform the touch thereof from a cold, high-tech appearance into a warm, natural appearance so as to increase the quality of the mobile phone. The fixing plate 164 inside the leather cover can effectively protect the display panel module 110, the keyboard module 120, the battery module 130 and the fixing frame 140 of the mobile phone.

The fixing plate 164 includes fixing devices 162, such as screw holes, to couple the changeable mobile phone leather cover 100 to the fixing frame 140 via the hole 142 of the fixing frame 140 and fixing devices 150, such as screws. Accordingly, the changeable mobile phone leather cover 100 according to the present invention can be easily fixed on the fixing frame 140. In addition, a user can efficiently change variously styled leather covers whenever the user desires to change the look and feel of the mobile phone. The changeable mobile phone leather cover 100 can be easily removed from the mobile phone by releasing the fixing devices 150 inside the mobile phone. Then, another style of changeable mobile phone leather cover 100 can be assembled on the mobile phone.

Since the changeable mobile phone leather cover 100 is made of leather, the mobile phone is similar to a wallet when the mobile phone is folded and is thus convenient to carry and maintain.

FIG. 1D illustrates another preferred embodiment of a changeable mobile phone leather cover according to the present invention. The changeable mobile phone leather cover 200 includes a front cover 260, a flexible portion 270, and a back cover 280. Similar to the preferred embodiment illustrated in FIG. 1C, the front cover 260 is formed by a leather layer 266 covered on the fixing plate 264 and is coupled to the back cover 280 by the flexible portion 270. The flexible portion 270 is preferably formed by the leather layer 266 extending from the front cover 260. The back cover 280 is also formed by a leather layer covering a fixing plate 264, and the leather layer of the back cover 280 is preferably formed by the leather layer 266 extending from the front cover 260.

Fixing devices 262 on the fixing plate 264 are preferably quick couplers, such as hooks, to directly insert into the fixing holes 142 of the fixing frame 140 and couple to the fixing holes 142, so that the changeable mobile phone leather cover 200 can be quickly assembled on the fixing frame 140. Users can quickly swap variously styled leather covers anytime. The changeable mobile phone leather cover 200 can be easily removed from the mobile phone by releasing the fixing devices 262 from the fixing holes 142 of the fixing frame 140. Then, another style of changeable mobile phone leather cover 100/200 can be quickly assembled on the mobile phone.

The changeable mobile phone leather cover according to the present invention utilizes the fixing plate to effectively protect the electronic components of the mobile phone and the fixing device to conveniently and quickly couple to the fixing frame of the mobile phone, thereby conveniently changing the leather cover for the mobile phone and improving the feel, quality and style of the mobile phone.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A changeable mobile phone leather cover, comprising:
a leather front cover composed of a first leather layer covering a first fixing plate, the first fixing plate further comprising a first fixing device for coupling to a mobile phone fixing frame;
a flexible portion coupling to the leather front cover; and
a leather back cover composed of a second leather layer covering a second fixing plate, the second fixing plate further comprising a second fixing device for coupling to the mobile phone fixing frame.

2. The changeable mobile phone leather cover of claim 1, wherein a display module, a keyboard module and a battery module are disposed inside the mobile phone fixing frame and the changeable mobile phone leather cover.

3. The changeable mobile phone leather cover of claim 1, wherein the changeable mobile phone leather cover is fixed to a mobile phone by a plurality of screws coupling to the first fixing device and the second fixing device through a plurality of fixing holes on the mobile phone fixing frame.

4. The changeable mobile phone leather cover of claim 1, wherein the first fixing device and the second fixing device comprise a plurality of hooks to couple to a plurality of fixing holes on the mobile phone fixing frame so as to fix the changeable mobile phone leather cover on a mobile phone.

5. The changeable mobile phone leather cover of claim 1, wherein the flexible portion is extended from the first leather layer.

6. The changeable mobile phone leather cover of claim 5, wherein the second leather layer is extended from the flexible portion.

7. The changeable mobile phone leather cover of claim 1, wherein the first fixing plate and the second fixing plate are made of a metal material.

8. The changeable mobile phone leather cover of claim 1, wherein the first fixing plate and the second fixing plate are made of a plastic material.

9. A changeable mobile phone leather cover, comprising:
a first fixing plate;
a leather layer covering the first fixing plate; and
a second fixing plate covered by the leather layer, wherein the leather layer forms a flexible portion between the first fixing plate and the second fixing plate to provide a folding function for a fixing frame of a mobile phone, and the first fixing plate and the second fixing plate further comprise a plurality of fixing devices for coupling to the fixing frame of the mobile phone.

10. The changeable mobile phone leather cover of claim 9, wherein a display module, a keyboard module and a battery module are disposed inside the fixing frame and the changeable mobile phone leather cover.

11. The changeable mobile phone leather cover of claim 9, wherein the changeable mobile phone leather cover is fixed to the mobile phone by a plurality of screws coupling to the fixing devices through a plurality of fixing holes on the fixing frame.

12. The changeable mobile phone leather cover of claim 9, wherein the fixing devices comprise a plurality of hooks to couple to a plurality of fixing holes on the fixing frame so as to fix the changeable mobile phone leather cover on the mobile phone.

13. The changeable mobile phone leather cover of claim 9, wherein the first fixing plate and the second fixing plate are made of a metal material.

14. The changeable mobile phone leather cover of claim 9, wherein the first fixing plate and the second fixing plate are made of a plastic material.

15. A mobile phone with a changeable mobile phone leather cover, comprising:
a foldable fixing frame;
a display module disposed inside the foldable fixing frame;
a keyboard module disposed inside the foldable fixing frame;
a battery module disposed between the foldable fixing frame and the keyboard module; and
a changeable mobile phone leather cover fixed on the foldable fixing frame, the changeable mobile phone leather cover further comprising:
a first fixing plate;
a leather layer covering the first fixing plate; and
a second fixing plate covered by the leather layer, wherein the leather layer forms a flexible portion between the first fixing plate and the second fixing plate to allow the foldable fixing frame folding, and the first fixing plate and the second fixing plate further comprise a plurality of fixing devices for coupling to the foldable fixing frame.

16. The mobile phone of claim 15, wherein the changeable mobile phone leather cover is fixed to the mobile phone by a plurality of screws coupling to the fixing devices through a plurality of fixing holes on the foldable fixing frame.

17. The mobile phone of claim 15, wherein the fixing devices comprise a plurality of hooks to couple to a plurality of fixing holes on the foldable fixing frame so as to fix the changeable mobile phone leather cover on the mobile phone.

18. The mobile phone of claim 15, wherein the first fixing plate and the second fixing plate are made of a metal material.

19. The mobile phone of claim 15, wherein the first fixing plate and the second fixing plate are made of a plastic material.

20. The mobile phone of claim 15, wherein the mobile phone is similar to a leather wallet when the mobile phone is folded.
